(19) United States
(12) Patent Application Publication
(10) Pub. No.: US 2025/0261694 A1
(43) Pub. Date: Aug. 21, 2025

(54) AEROSOL-GENERATING DEVICE AND MICROWAVE HEATING ASSEMBLY THEREOF

(71) Applicant: SMOORE INTERNATIONAL HOLDINGS LIMITED, George Town (KY)

(72) Inventors: Dongjian LI, Shenzhen (CN); Jing DU, Shenzhen (CN); Feng LIANG, Shenzhen (CN)

(21) Appl. No.: 19/199,826

(22) Filed: May 6, 2025

Related U.S. Application Data
(63) Continuation of application No. PCT/CN2022/133008, filed on Nov. 18, 2022.

(30) Foreign Application Priority Data
Nov. 7, 2022 (CN) 202211386129.1

(51) Int. Cl. A24F 40/46; A24F 40/51; H05B 6/64; H05B 6/80

(52) U.S. Cl. CPC A24F 40/46; A24F 40/51; H05B 6/645; H05B 6/80

(57) ABSTRACT

A microwave heating assembly for an aerosol-generating device and heating an aerosol generation product, the microwave heating assembly including: an outer conductor unit having a tubular shape and a first open end and a second open end opposite the first open end; and an inner conductor unit arranged in the outer conductor unit and forming an accommodating space for accommodating the aerosol generation product. The inner conductor unit has a first fixed end and a first free end. The first fixed end is combined on an end wall of the first open end. The first free end extends toward the second open end. The accommodating space is between the first fixed end and the first free end.

### CROSS-REFERENCE TO PRIOR APPLICATION

This application is a continuation of International Patent Application No. PCT/CN2022/133008, filed on Nov. 18, 2022, which claims priority to Chinese Patent Application No. 202211386129.1, filed on Nov. 7, 2022. The entire disclosure of both applications is hereby incorporated by reference herein.

### FIELD

The present invention relates to the field of electronic atomization, and in particular, to an aerosol-generating device and a microwave heating assembly thereof.

### BACKGROUND

In the related art, a microwave-heating aerosol-generating device includes a microwave heating assembly. The microwave heating assembly includes an outer conductor unit, an inner conductor column, an accommodating base, and a probe unit. The outer conductor unit is in a tubular shape, and includes a closed end and an open end opposite to each other. One end of the inner conductor column is coaxially fixed at the closed end of the outer conductor unit, and the other end of the inner conductor column extends toward the open end of the outer conductor unit. The accommodating base is mounted on the open end of the outer conductor unit, and has an accommodating cavity arranged in the outer conductor unit. The accommodating cavity is configured to load an aerosol generation product. One end of the probe unit is embedded at one end of the inner conductor column extending toward the open end, and the other end of the probe unit extends toward the open end of the outer conductor unit and extends into the accommodating cavity, to transmit microwaves.

However, after the accommodating base is mounted on the open end of the outer conductor unit, the entire microwave heating assembly is basically in a closed structure, which is not conducive to heat dissipation. In addition, when microwave heating is performed, a large part of generated heat is conducted to the outer conductor unit through the accommodating base, resulting in a high housing temperature of the outer conductor unit, thereby affecting overall temperature distribution of the aerosol-generating device, efficiency of microwave feeding, and inhalation experience of a user.

### SUMMARY

In an embodiment, the present invention provides a microwave heating assembly for an aerosol-generating device and heating an aerosol generation product, the microwave heating assembly comprising: an outer conductor unit having a tubular shape and comprising a first open end and a second open end opposite the first open end; and an inner conductor unit arranged in the outer conductor unit and forming an accommodating space configured to accommodate the aerosol generation product, wherein the inner conductor unit comprises a first fixed end and a first free end, wherein the first fixed end is combined on an end wall of the first open end, wherein the first free end extends toward the second open end, and wherein the accommodating space is between the first fixed end and the first free end.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of an external structure of a microwave heating assembly according to an embodiment 1 of the present invention;

FIG. 2 is a cross-sectional view of a longitudinal structure of the microwave heating assembly shown in FIG. 1;

FIG. 3 is a cross-sectional view of a longitudinal structure of the microwave heating assembly shown in FIG. 1 in a disassembled state;

FIG. 4 is a structural perspective view of an outer conductor unit and a first inner conductor unit that are integrally combined according to an embodiment 1 of the present invention;

FIG. 5 is a schematic diagram of a structure of a first accommodating base according to an embodiment 1 of the present invention;

FIG. 6 is a scattering parameter diagram of a microwave heating assembly after an aerosol generation product is inserted during initial heating according to an embodiment 1 of the present invention;

FIG. 7 is a scattering parameter diagram of a microwave heating assembly after an aerosol generation product is inserted during heating and inhalation according to an embodiment 1 of the present invention;

FIG. 8 is a schematic diagram of an external structure of a microwave heating assembly according to an embodiment 2 of the present invention;

FIG. 9 is a cross-sectional view of a longitudinal structure of an outer conductor unit and a second inner conductor unit that are integrally combined according to an embodiment 2 of the present invention;

FIG. 10 is a structural perspective view of an outer conductor unit and a second inner conductor unit that are integrally combined according to an embodiment 3 of the present invention;

FIG. 11 is a cross-sectional view of a longitudinal structure of an outer conductor unit and a second inner conductor unit that are integrally combined according to an embodiment 3 of the present invention;

FIG. 12 is a structural perspective view of an outer conductor unit and a third inner conductor unit that are integrally combined according to an embodiment 4 of the present invention;

FIG. 13 is a cross-sectional view of a longitudinal structure of an outer conductor unit and a third inner conductor unit that are integrally combined according to an embodiment 4 of the present invention;

FIG. 14 is a cross-sectional view of a longitudinal structure of a microwave heating assembly according to an embodiment 5 of the present invention;

FIG. 15 is a schematic diagram of a structure of a second accommodating base according to an embodiment 5 of the present invention;

FIG. 16 is a cross-sectional view of a longitudinal structure of a microwave heating assembly according to an embodiment 6 of the present invention; and

FIG. 17 is a schematic diagram of a structure of a third accommodating base according to an embodiment 6 of the present invention.

### DETAILED DESCRIPTION

In an embodiment, the present invention provides an improved aerosol-generating device and a microwave heating assembly thereof.

In an embodiment, the present invention provides a microwave heating assembly, used in an aerosol-generating device, and configured to heat an aerosol generation product, and the microwave heating assembly includes:
an outer conductor unit, being in a tubular shape, and including a first open end and a second open end opposite to the first open end; and
an inner conductor unit, arranged in the outer conductor unit, and forming accommodating space configured to accommodate the aerosol generation product, where
the inner conductor unit includes a first fixed end and a first free end, the first fixed end is combined on the end wall of the first open end, the first free end extends toward the second open end, and the accommodating space is between the first fixed end and the first free end.

In some embodiments, the accommodating space runs through the inner conductor unit in the longitudinal direction.

In some embodiments, the first fixed end is integrally combined on the end wall of the first open end.

In some embodiments, the inner conductor unit includes at least two extension portions, the at least two extension portions are distributed spaced away in the outer conductor unit along an annular path, and the accommodating space includes a channel formed between the at least two extension portions; and
each extension portion includes a second fixed end and a second free end, the second fixed end is integrally connected to the end wall of the first open end, and the second free end extends toward the second open end.

In some embodiments, the extension portion is in a longitudinal shape, and the extension direction of the extension portion is parallel to the axial direction of the outer conductor unit.

In some embodiments, the at least two extension portions include the wall surface configured to be tightly attached to the outer peripheral surface of the aerosol generation product.

In some embodiments, the shape of the extension portion includes a longitudinal arc shape, a straight strip shape, a curve shape, or a combination of at least one of the shapes.

In some embodiments, the at least two extension portions include at least two pairs of extension portions having unequal lengths between pairs, and the at least two pairs of extension portions are alternately and evenly distributed in the outer conductor unit in an annular shape.

In some embodiments, the outer conductor unit includes: the conductor side wall, being in a tubular shape, and having the first end and the second end opposite to each other, the first end and the second end being both open structures, and the second end forming the second open end; and
the first end wall, sealed at the first end of the conductor side wall, and the first end wall is provided with an axial running-through through hole, to form the first open end.

In some embodiments, the aperture of the through hole is slightly larger than or equal to the diameter of the aerosol generation product.

In some embodiments, the at least two extension portions are equally spaced away in the circumferential direction of the through hole.

In some embodiments, the outer conductor unit includes the longitudinal axis, and the side surface that is of the extension portion and that faces the longitudinal axis is flush with the edge of the through hole.

In some embodiments, the inner conductor unit further includes a conductor portion; and
the conductor portion is in a tubular shape, and includes the first end surface and the second end surface opposite to each other; the first end surface is integrally connected to the end wall of the first open end; second fixed ends of the at least two extension portions are respectively integrally connected to the second end surface; a central channel of the conductor portion is in communication with the first open end; and the accommodating space further includes the central channel of the conductor portion.

In some embodiments, the conductor portion is in a cylindrical shape.

In some embodiments, the conductor portion is coaxial with the outer conductor unit.

In some embodiments, the inner diameter of the conductor portion is equal to or slightly larger than the diameter of the aerosol generation product.

In some embodiments, the microwave heating assembly further includes a temperature measurement assembly configured to measure a temperature, and the temperature measurement assembly is embedded in one of the extension portions.

In some embodiments, the microwave heating assembly is provided with an accommodating hole configured to accommodate the temperature measurement assembly; and
the accommodating hole is a blind hole, runs through the first end wall in the direction parallel to the axis of the outer conductor, and extends toward the second free end of the extension portion corresponding to the highest electric field strength.

In some embodiments, the inner conductor unit further includes a hollowed portion arranged on the conductor portion and/or the extension portion.

In some embodiments, the shape of the hollowed portion includes a round shape, a square shape, or a curved shape.

In some embodiments, the microwave heating assembly further includes:
an accommodating base, mounted on the inner conductor unit, where the accommodating base includes a first closed end and a third open end opposite to each other, the first closed end is located between the second free end and the second open end, and the third open end extends toward and is in communication with the first open end, and
the accommodating base further includes an accommodating cavity between the first closed end and the third open end, and the accommodating cavity is configured to load the aerosol generation product.

In some embodiments, the accommodating base is sleeved on the outer peripheries of the at least two extension portions, and the side surfaces and the bottom surfaces of the at least two extension portions are respectively attached to the inner wall surface of the accommodating base.

In some embodiments, the accommodating base is arranged in the accommodating space, the at least two extension portions surround the outer periphery of the accommodating base, and the side surfaces of the at least two extension portions are attached to the outer peripheral side wall of the accommodating base.

In some embodiments, the side wall of the accommodating base is provided with at least two slots corresponding to positions of the at least two extension portions, and the at least two slots respectively run through the end surface of the third open end, and extend toward the first closed end; and
the accommodating base is engaged with the at least two extension portions through the at least two slots, and is embedded on the inner conductor unit.

In some embodiments, the first closed end is provided with the inner side end surface facing the first open end; and
the inner side end surface is configured to abut against the bottom end surface of the aerosol generation product, and an air inlet gap is formed between the bottom end surface and the inner side end surface when the bottom end surface abuts against the inner side end surface.

In some embodiments, the microwave heating assembly further includes a microwave feeding unit, and the microwave feeding unit includes:
an outer conductor, being in a tubular shape, embedded on the side wall of the outer conductor unit, and being in ohmic contact with the outer conductor unit;
an inner conductor, being in a straight shape, arranged in the outer conductor, where the inner conductor extends into the outer conductor unit, and is in ohmic contact with the inner conductor unit; and
a medium layer, being between the inner conductor and the outer conductor.

The present invention further provides an aerosol-generating device. The aerosol-generating device includes a microwave generation device, and further includes the foregoing microwave heating assembly. The microwave heating assembly is connected to the microwave generation device, and is in ohmic contact with the microwave generation device.

### BENEFICIAL EFFECTS

Implementation of the present invention has the following beneficial effects: in the present invention, the accommodating space configured to accommodate the aerosol generation product is formed in the inner conductor unit of the microwave heating assembly, so that the accommodating base directly fixed to the outer conductor unit may not be needed, which can avoid heat being directly transferred to the outer conductor unit through the accommodating base, thereby preventing an excessively high temperature of the outer conductor unit.

In addition, the outer conductor unit includes the second open end, and the entire microwave heating assembly is open arranged. This can improve a heat dissipation effect, and improve overall temperature distribution of the aerosol-generating device, efficiency of microwave feeding, and user experience.

In the drawings: Microwave heating assembly 1; Aerosol generation product 2; Outer conductor unit 11; First inner conductor unit 12; Microwave feeding unit 13; First accommodating base 14; Cavity 111; First open end 112; Second open end 113; Conductor side wall 114; First end wall 115; Feeding hole 1141; Through hole 1151; First fixed end 121; First free end 122; First extension portion 123; First accommodating space 124; Second fixed end 1231; Second free end 1232; Insertion hole 1233; Outer conductor 131; Inner conductor 132; Medium layer 133; First closed end 141; Third open end 142; First accommodating cavity 143; Air inlet gap 144; Slot 145;

Accommodating hole 125;

Second inner conductor unit 12a; Second extension portion 123a; Second accommodating space 124a;

Third inner conductor unit 12b; Third extension portion 123b; Third accommodating space 124b; Conductor portion 126b; First end surface 1261b; Second end surface 1262b; Third fixed end 1231b; Third free end 1232b;

Second accommodating base 14a; Second closed end 141a; Fourth open end 142a;

Second accommodating cavity 143a; Perforation 146a;

Third accommodating base 14b; Third closed end 141b; Fifth open end 142b; Third accommodating cavity 143b.

To provide a clearer understanding of the technical features, objectives, and effects of the present invention, specific implementations of the present invention are described in detail with reference to the accompanying drawings. In the following descriptions, it should be understood that, orientation or position relationships indicated by the terms such as “front”, “rear”, “upper”, “lower”, “left”, “right”, “longitudinal”, “transverse”, “vertical”, “horizontal”, “top”, “bottom”, “inner”, “outer”, “head”, and “tail” are based on orientation or position relationships shown in the accompanying drawings and structures and operations in specific orientations, and are used only for ease of description of the technical solutions, rather than indicating that the mentioned device or element needs to have a specific orientation. Therefore, such terms should not be construed as a limitation on the present invention.

It should be further noted that, unless otherwise clearly specified and limited, terms such as “mounted”, “connected”, “connected”, “fixed”, and “arranged” should be understood in a generalized manner, for example, may be understood as a fixed connection, a detachable connection, or integration; or may be understood as a mechanical connection or an electrical connection; or may be understood as a direct connection, an indirect connection via a medium, an internal communication of two elements, or a mutual relationship between two elements. When an element is referred to as being “upper” or “lower” another element, the element can be “directly” or “indirectly” located above the another element, or one or more intervening elements may also exist. The terms “first”, “second”, “third”, and the like are merely for ease of describing the technical solutions, and should not be understood as indicating or implying relative importance or implicitly specifying the quantity of the indicated technical features. Therefore, a feature limited to “first”, “second”, “third”, and the like may explicitly or implicitly include one or more of the features. A person skilled in the art may understand the specific meanings of the foregoing terms in the present invention based on specific situations.

In the following descriptions, for the purpose of illustration rather than limitation, specific details such as the specific system structure and technology are provided, to thoroughly understand the embodiments of the present invention. However, it should be clear to a person skilled in the art that the present invention may also be implemented in other embodiments without these specific details. In other cases, detailed descriptions of well-known systems, devices, circuits, and methods are omitted, so as not to obscure the descriptions of the present invention with unnecessary details.

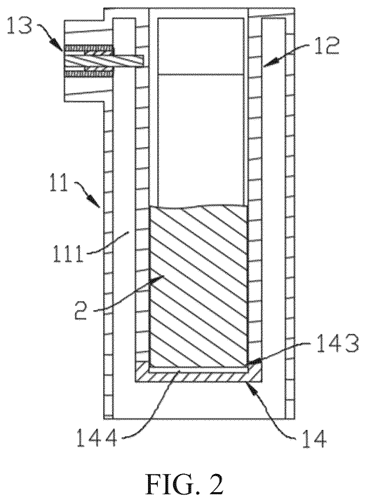

According to the present invention, an acrosol-generating device is constructed. The aerosol-generating device may use microwaves to heat an aerosol generation product 2 (referring to FIG. 2), to generate an aerosol through atomization for a user to inhale. The aerosol generation product 2 is a solid aerosol generation product such as a processed plant leaf product. It may be understood that, the acrosol generation product 2 may also be a liquid aerosol generation product.

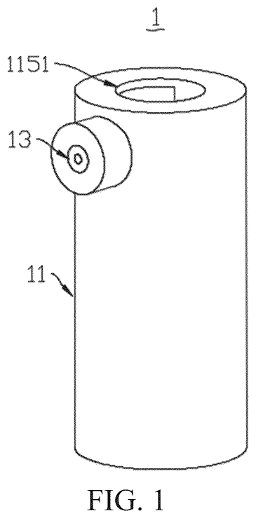

The aerosol-generating device may include a microwave generation device and a microwave heating assembly 1 (referring to FIG. 1). The microwave generation device is configured to generate microwaves. The generated microwaves may be fed to the microwave heating assembly 1, to form a microwave field in a cavity 111 of the microwave heating assembly 1. A region with strong microwaves in the microwave field is used as a heating region, and acts on a part of the acrosol generation product 2 arranged in the heating region.

As shown in FIG. 1, the entire shape of the microwave heating assembly 1 is approximately in a cylindrical shape. Certainly, the microwave heating assembly 1 is not limited to being in a cylindrical shape, and may also be in another shape such as a square cylindrical shape or an elliptical cylindrical shape.

As shown in FIG. 2, in an embodiment 1, the microwave heating assembly 1 may include an outer conductor unit 11, a first inner conductor unit 12 arranged in the outer conductor unit 11, and a medium (for example, air); and further include a microwave feeding unit 13 and a first accommodating base 14. The outer conductor unit 11 may define the cavity 111, and the cavity 111 is used as a place for microwave heating. The first inner conductor unit 12 is coaxially arranged in the cavity 111, and is configured to adjust a resonance frequency and microwave distribution in the cavity 111, to clamp and fix the aerosol generation product 2. The first accommodating base 14 is coaxially mounted on the first inner conductor unit 12, and cooperates with the first inner conductor unit 12, to completely wrap the lower structure of the aerosol generation product 2. The microwave feeding unit 13 is mounted on the outer conductor unit 11, and may feed microwaves generated by the microwave generation device to the outer conductor unit 11 and the first inner conductor unit 12, to form the microwave field in the cavity 111.

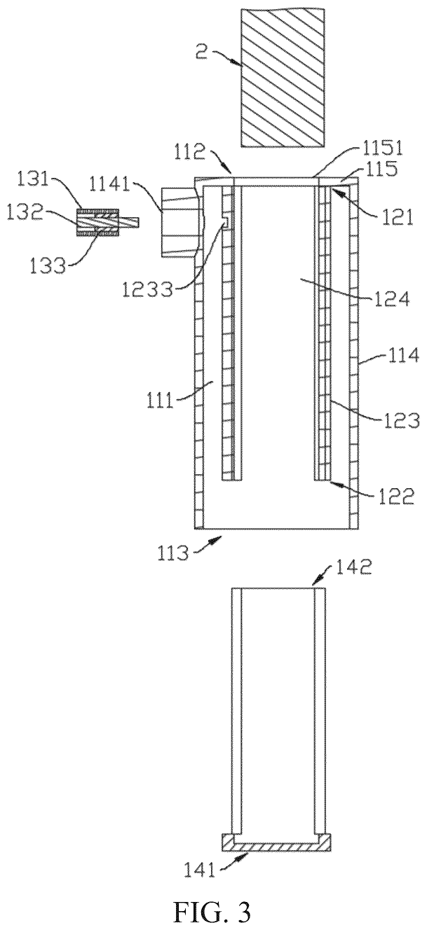

As shown in FIG. 3, the outer conductor unit 11 is in a tubular shape, and has the first open end 112 and the second open end 113 opposite to each other and the cavity 111 between the first open end 112 and the second open end 113, and the cavity 111 is in a cylindrical shape. Certainly, the outer conductor unit 11 is not limited to being in a cylindrical shape, and may also be in another shape such as a square cylindrical shape or an elliptical cylindrical shape. The first open end 112 is configured to allow the aerosol generation product 2 to pass through and be inserted into the cavity 111. The second open end 113 is configured to: reduce heat conduction of the acrosol generation product 2 to the outer conductor unit 11 during heating, reduce a heating degree of the outer conductor unit 11, and increase a heat dissipation effect. In addition, microwaves can be prevented from leaking from the second open end 113 to the outside, so that the microwaves can be absorbed by the aerosol generation product 2 as much as possible.

The outer conductor unit 11 is integrally formed from a conductive metal material. Preferably, the metal material is aluminum alloy or copper, which have high electrical and thermal conductivity. Alternatively, the outer conductor unit 11 is formed by plating a first conductive coating on the inner wall surface of a non-conductive cylinder. A material forming the first conductive coating may include gold, silver, copper, aluminum, a conductive metal oxide (ITO, AZO, AGZO, FTO, or the like), a conductive polymer, or the like, and preferably, the material is gold or silver. In this embodiment, the outer conductor unit 11 may include a conducive conductor side wall 114 and a first end wall 115. The conductor side wall 114 is in a tubular shape, and both the top end and the bottom end of the conductor side wall 114 is in the open structure. The first end wall 115 is configured to cover the top end of the conductor side wall 114. In addition, the first end wall 115 is provided with an axial running-through through hole 1151, to form the first open end 112 of the outer conductor unit 11. The cavity 111 is in communication with the outside through the through hole 1151, and the aperture of the through hole 1151 is slightly larger than or equal to the outer diameter of the aerosol generation product 2. The second open end 113 of the outer conductor unit 11 is formed at the bottom end of the conductor side wall 114.

In addition, as shown in FIG. 3, a radial running-through feeding hole 1141 is provided on the conductor side wall 114 close to the first end wall 115. The feeding hole 1141 may be configured to allow the microwave feeding unit 13 to be inserted into the outer conductor unit 11. The aperture of the feeding hole 1141 matches the outer diameter of an outer conductor 131 of the microwave feeding unit 13.

The first inner conductor unit 12 and the outer conductor unit 11 are integrated to reduce the number of assembly components and lower costs. In addition, processing and assembly procedures of the microwave heating assembly 1 can be simplified, a success rate of batch assembly of the microwave heating assembly 1 is improved, and an error problem, for example, problems such as a conductor column is prone to be deviated from the center and a mounting angle is deviated, in an assembly process can be avoided. As shown in FIG. 3, the first inner conductor unit 12 is arranged in the cavity 111 of the outer conductor unit 11, and the axial height of the first inner conductor unit 12 is smaller than the axial height of the cavity 111. The first inner conductor unit 12 has a first fixed end 121 and a first free end 122. The first fixed end 121 is integrally combined on the first end wall 115 at a peripheral position of the through hole 1151, and the first free end 122 extends toward the second open end 113 of the outer conductor unit 11, and is suspended in the cavity 111. The first inner conductor unit 12 may define first accommodating space 124 in the cavity 111. The first accommodating space 124 is formed to run through the first inner conductor unit 12 in the longitudinal direction, so that the aerosol generation product 2 can pass through the first accommodating space 124 when extending into the cavity 111. In addition, the inner wall surface of the first accommodating space 124 may be tightly attached to the outer peripheral surface of the aerosol generation product 2, to clamp and fix the aerosol generation product 2.

Optionally, the first inner conductor unit 12 may be integrally made of a conductive metal material, and preferably, the metal material is aluminum alloy or copper. Certainly, the first inner conductor unit 12 is not limited to being integrally made of a conductive material, and may also be implemented by plating a second conductive coating on the external surface of a non-conductor. Preferably, the second conductive coating is plated with a silver coating or a gold coating.

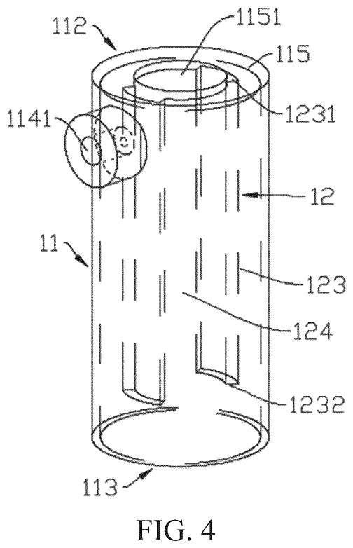

In this embodiment, referring to FIG. 3 and FIG. 4, the first inner conductor unit 12 may include two first extension portions 123. The two first extension portions 123 are mirror-symmetrical along the axis of the outer conductor unit 11, and are arranged in the circumferential direction of the first end wall 115 at the edge of the through hole 1151. Preferably, the inner recess peripheral surfaces of the two first extension portions 123 are flush with the edge of the through hole 1151. The extension direction of the entire first extension portion 123 is parallel to the axial direction of the outer conductor unit 11. The first accommodating space 124 is formed between the two first extension portions 123, and is approximately a cylindrical channel.

The first extension portion 123 is in the longitudinal arc structure, and may include a second fixed end 1231 and a second free end 1232. The second fixed end 1231 is integrally combined on the first end wall 115 at the edge of the through hole 1151, and the second free end 1232 extends toward the second open end 113 of the outer conductor unit 11. When the microwaves are fed, the second free end 1232 of the first extension portion 123 may generate a strong microwave field, to rapidly heat the aerosol generation product 2.

Preferably, the radian of the inner recess peripheral surface of the first extension portion 123 matches the radian of the outer peripheral surface of the aerosol generation product 2, so that when the aerosol generation product 2 extends into the first accommodating space 124, the outer peripheral surface of the aerosol generation product 2 may be tightly attached to the inner recess peripheral surface of the first extension portion 123.

It is to be understood that, because most of the aerosol generation products 2 are in cylindrical shapes, the first extension portion 123 of the present invention is constructed as the arc-shaped structure, and matches the shape of the aerosol generation product 2, to be attached to the form of the aerosol generation product 2, thereby effectively heating the aerosol generation product 2 and greatly improving heating uniformity and a range of the acrosol generation product 2. Certainly, the first extension portion 123 is not limited to being in the arc-shaped structure, and may also be in another structure such as a straight strip-shaped structure or a curved structure, or may be a combination of at least one of the arc-shaped structure, the straight strip-shaped structure, and the curved structure.

Optionally, as shown in FIG. 3, one of the first extension portions 123 may be arranged at a relative position of the feeding hole 1141 of the outer conductor unit 11, and the outer convex peripheral surface of the first extension portion 123 is provided with an insertion hole 1233 for the inner conductor 132 of the microwave feeding unit 13 to be inserted. The insertion hole 1233 is configured to improve reliability of a connection between the inner conductor 132 and the first extension portion 123, to avoid poor contact. When the microwave feeding unit 13 is mounted on the outer conductor unit 11, the inner conductor 132 of the microwave feeding unit 13 is inserted into the insertion hole 1233, and is in close contact with the inner wall surface of the insertion hole 1233, thereby forming a good ohmic contact.

In this embodiment, the insertion hole 1233 is a blind hole, is formed on the first extension portion 123 adjacent to the feeding hole 1141 in the axial direction perpendicular to the outer conductor unit 11, and the orifice of the insertion hole 1233 is opposite to the feeding hole 1141. The aperture of the insertion hole 1233 matches the diameter of the inner conductor 132 of the microwave feeding unit 13. Optionally, the shape of the insertion hole 1233 may be a round shape, a square shape, an elliptical shape, or another polygonal shape. Certainly, in this embodiment, the insertion hole 1233 may not be necessary, and the insertion hole 1233 is used in this embodiment as an optional solution. When the insertion hole 1233 is not provided, the inner conductor 132 of the microwave feeding unit 13 may directly abut against the surface of the first extension portion 123 adjacent to the feeding hole 1141, and is in ohmic contact with the first extension portion 123.

Optionally, different polygonal shapes such as a round shape, a rectangular shape, and a curved shape may be hollowed on the surface of the first extension portion 123, to form one or more hollowed portions. The hollowed portion may be conducive to enhancing local microwave field strength of the first inner conductor unit 12, and is conducive to improving the heating uniformity of the acrosol generation product 2.

As shown in FIG. 3, the microwave feeding unit 13 may be a coaxial connector, and is mounted on the outer conductor unit 11 from the feeding hole 1141 of the outer conductor unit 11. A feeding manner of the microwave feeding unit 13 may be an electric feeding manner or a magnetic feeding manner, and preferably, the feeding manner is the electric feeding manner.

The microwave feeding unit 13 includes the tubular outer conductor 131, the inner conductor 132 arranged in the outer conductor 131, and a medium layer 133 between the inner conductor 132 and the outer conductor 131. When the microwave feeding unit 13 is mounted on the feeding hole 1141, the inner conductor 132 of the microwave feeding unit 13 is in ohmic contact with the first extension portion 123 of the first inner conductor unit 12, and the outer conductor 131 of the microwave feeding unit 13 is in ohmic contact with the inner wall surface of the feeding hole 1141.

In this embodiment, the outer conductor 131 is in a cylindrical shape, and two ends of the outer conductor 131 are in open structures. The inner conductor 132 is in the straight shape, and is inserted into the insertion hole 1233 of the first inner conductor unit 12 in the direction perpendicular to the axis of the outer conductor unit 11, to be in close contact with the first extension portion 123, thereby forming a good ohmic contact.

As shown in FIG. 2, the first accommodating base 14 is coaxially mounted on the bottom of the first inner conductor unit 12, and may cooperate with the two first extension portions 123 of the first inner conductor unit 12 to wrap the lower structure of the aerosol generation product 2 and also support the aerosol generation product 2.

The first accommodating base 14 may be made of a material having low microwave losses, so that generation of condensate when the first extension portion 123 heats the aerosol generation product 2 to generate aerosols may be reduced, and cleanliness inside the cavity 111 is further improved. Optionally, the material having low microwave losses may include materials such as PI, PEEK, and PTFE.

As shown in FIG. 3, the first accommodating base 14 is approximately in a tubular shape, and the inner diameter of the first accommodating base is larger than the outer diameter of the aerosol generation product 2. In this embodiment, the first accommodating base 14 includes a first closed end 141 and a third open end 142. The first closed end 141 is located between the second free end 1232 of the first extension portion 123 and the second open end 113 of the outer conductor unit 11. The third open end 142 extends toward the first open end 112 of the outer conductor unit 11.

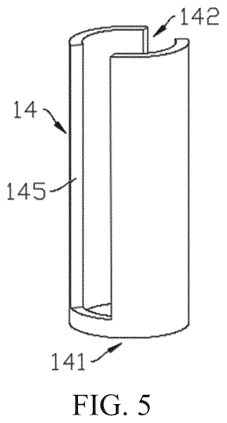

Referring to FIG. 3 and FIG. 5, the outer peripheral wall surface of the first accommodating base 14 is provided with two slots 145 for the first extension portion 123 of the first inner conductor unit 12 to be inserted. The two slots 145 are both longitudinal arc-shaped channels, and are mirror-symmetrical along the axis of the first accommodating base 14. The two slots 145 respectively correspond to positions of the two first extension portions 123, run through the end surface of the first accommodating base 14 at the third open end 142, and extend toward the first closed end 141 in the direction parallel to the axial direction of the first accommodating base 14. There is a spacing between bottom wall surfaces of the two slots 145 and the first closed end 141. It may be understood that, the quantity, the shape, and the size of the slots 145 respectively correspond to the quantity, the shape, and the size of the first extension portion 123.

Referring to FIG. 2, when the first accommodating base 14 is mounted on the bottom of the first inner conductor unit 12, the two first extension portions 123 are respectively engaged in the two slots 145, and the side plane along the circumferential direction and the bottom surface of the first extension portion 123 are attached to the inner wall surface of the slots 145. In this case, two projections of the first accommodating base 14 and the first inner conductor unit 12 respectively on the second end wall of the outer conductor unit 11 partially/completely overlap. The inner recess peripheral surfaces of the two first extension portions 123 and the inner peripheral surface of the first accommodating base 14 together define a first accommodating cavity 143 closed in the circumferential direction and at the bottom. The first accommodating cavity 143 accommodates the lower structure of the aerosol generation product 2 therein.

Optionally, the inner side end surface of the first accommodating base 14 facing the first open end 112 is provided with one or more protrusions or grooves, or the bottom of the first accommodating base 14 is provided with one or more axial running-through air holes, to form an air inlet gap 144 (referring to FIG. 2) located between the bottom of the first accommodating base 14 and the bottom end surface of the aerosol generation product 2. The air inlet gap 144 may prevent the bottom end surface of the aerosol generation product 2 from completely contacting the bottom of the first accommodating base 14, resulting in poor air flow.

It should be noted that, the first accommodating base 14 may not be necessary in the microwave heating assembly 1. The first accommodating base 14 is used in this embodiment as an optional solution, which aims to reduce generation of condensate when the first extension portion 123 heats the aerosol generation product 2 to generate aerosols and further improve cleanliness inside the cavity 111.

However, when the first accommodating base 14 is omitted, the two first extension portions 123 may be relied on to clamp the aerosol generation product 2 extending into the cavity 111, to fix the aerosol generation product 2. In addition, because the first accommodating base 14 may absorb some microwave energy, a heating effect of the aerosol generation product 2 may be affected during the microwave heating. After the first accommodating base 14 is omitted, it is conducive to increasing an amount of microwave energy absorption of the aerosol generation product 2, thereby increasing a carbonization effect after the aerosol generation product 2 is entirely inhaled and reducing power consumption losses.

Electric field strength data and microwave feeding data of an improved microwave heating assembly 1 in an embodiment 1 of the present invention are specifically described through experimental data.

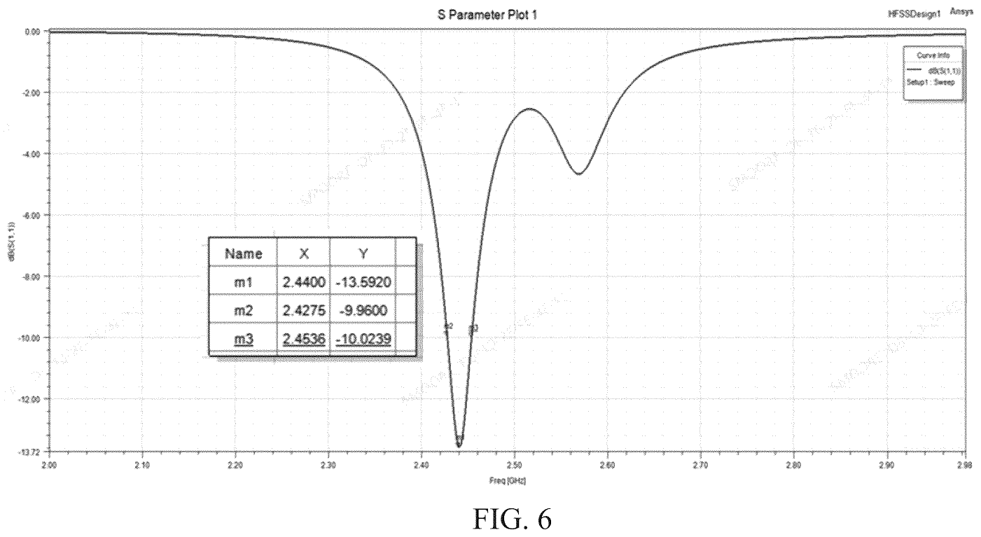

As shown in FIG. 6, the figure shows a scattering parameter of the microwave heating assembly 1 during initial heating after the aerosol generation product 2 is inserted according to an embodiment 1 of the present invention. It can be seen from FIG. 6 that, when the aerosol generation product 2 is inserted into the cavity, initial feeding efficiency (greater than 95%) 111 is high: frequency is 2.44 GHz, and the scattering parameter S11 is −13.6 dB.

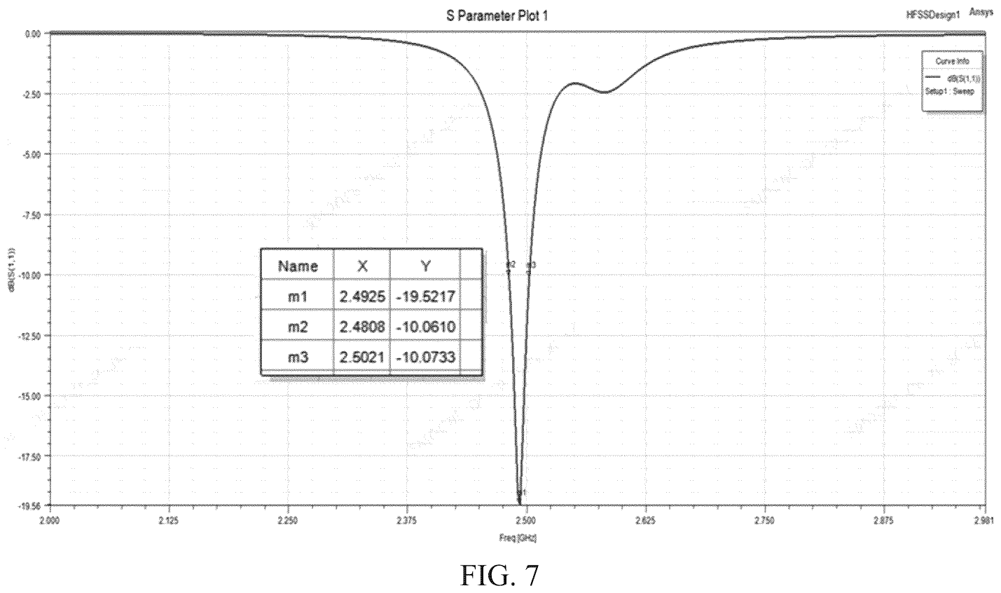

As shown in FIG. 7, the figure shows a scattering parameter of the microwave heating assembly 1 during heating and inhalation after the aerosol generation product 2 is inserted according to an embodiment 1 of the present invention. It can be seen from FIG. 7 that, when the aerosol generation product 2 is heated and inhaled, the cavity 111 maintains high feeding efficiency (greater than 95%): the frequency is 2.49 GHz, and the scattering parameter S11 is −19.5 dB.

It can be seen that, when the microwave heating assembly 1 is assembled with the aerosol generation product 2, a resonance frequency may be in a range of 2.4 GHz to 2.5 GHz.

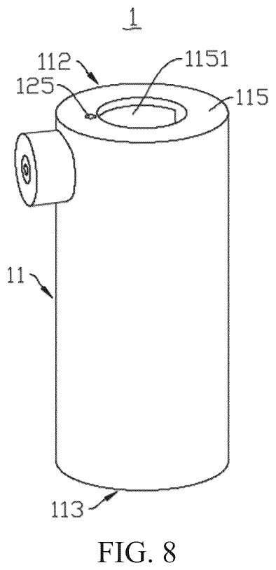

Referring to FIG. 8 together, FIG. 8 is a microwave heating assembly 1 according to an embodiment 2 of the present invention. This embodiment 2 is an improvement based on the embodiment 1. Specifically, a temperature measurement assembly configured to perform temperature measurement and temperature control on the aerosol generation product 2 is added to the microwave heating assembly 1.

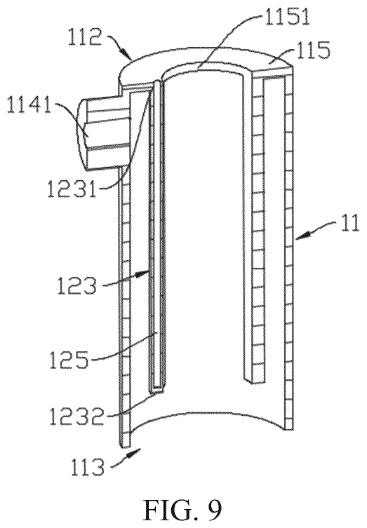

As shown in FIG. 8 and FIG. 9, a hole is punched on the first end wall 115 of the outer conductor unit 11 in the vertical direction, runs through the first end wall 115, and extends axially toward the inside of one of first extension portions 123 (preferably the first extension portion 123 having the strongest electric field strength in the first inner conductor unit 12), to form an accommodating hole 125 configured to accommodate the temperature measurement assembly. The accommodating hole 125 is a blind hole, and the bottom of the accommodating hole 125 is located at the second free end 1232 of the first extension portion 123 (because an electric field strength at the second free end 1232 of the first extension portion 123 is the strongest). A temperature measurement probe of the temperature measurement assembly is arranged at the bottom of the accommodating hole 125, and the temperature measurement probe is electrically connected to a temperature control and measurement circuit located outside the microwave heating assembly 1, to perform temperature measurement and temperature control on the aerosol generation product 2 during microwave heating. In addition, the inner recess peripheral surfaces of the two first extension portions 123 may be in close contact with the outer peripheral surface of the aerosol generation product 2, to ensure accuracy of the temperature measurement and the temperature control.

It may be understood that, in the related art, the temperature measurement assembly is arranged inside the probe to implement the temperature measurement and the temperature control. However, this causes fouling dirt generated due to the aerosol generation product remaining on the external surface of the probe after microwaving heating, and the fouling dirt remaining on the probe may further affect accuracy of the temperature measurement and the temperature control. In this embodiment, the temperature measurement assembly is arranged in the first extension portion 123 to implement the temperature measurement and the temperature control, thereby avoiding a problem that the probe needs to be cleaned after inhalation ends and improving use experience of the user.

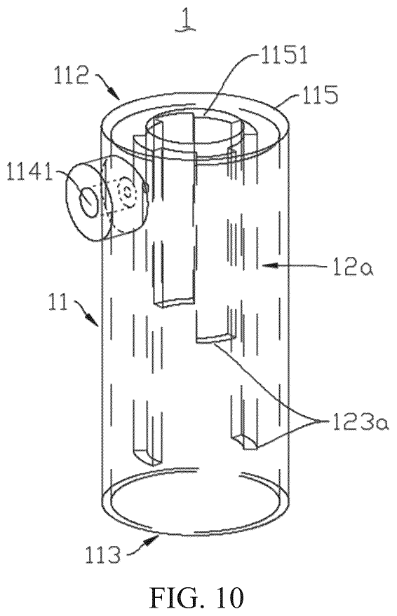

Referring to FIG. 10 together, FIG. 10 is a microwave heating assembly 1 according to an embodiment 3 of the present invention. This embodiment 3 is an improvement based on the embodiment 1. Specifically, the first inner conductor unit 12 in the foregoing embodiments is replaced with a second inner conductor unit 12a.

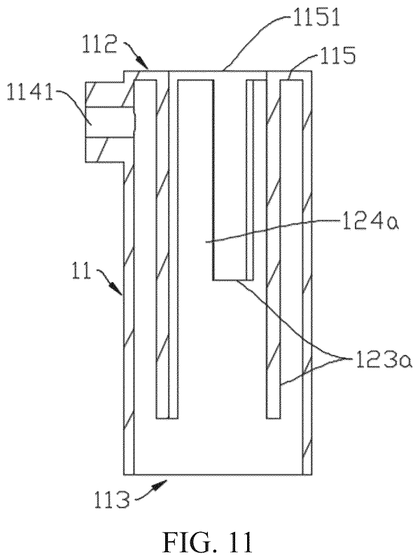

As shown in FIG. 10 and FIG. 11, a difference between the second inner conductor unit 12a and the first inner conductor unit 12 is that the second inner conductor unit 12a includes two pairs of second extension portions 123a (for the shape of the second extension portion 123a, refer to the first extension portion 123), and the two pairs of second extension portions 123a are alternately and evenly distributed in the circumferential direction of the first end wall 115 at the edge of the through hole 1151. In the two pairs of second extension portions 123a, the second extension portions 123a of the same pair are equal in length, and are mirror-symmetrical along the axis of a conductor portion 126b. The second extension portions 123a of the non-same pair have different lengths. It may be understood that, the inner recess peripheral surfaces of the two pairs of second extension portions 123a together define second accommodating space 124a. The second accommodating space 124a is approximately a cylindrical channel, to better clamp and fix the aerosol generation product 2.

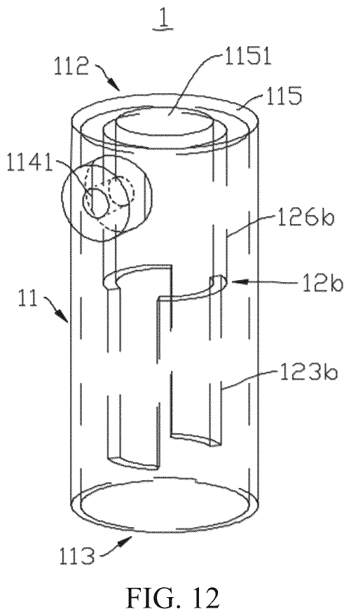

Referring to FIG. 12 together, FIG. 12 is a microwave heating assembly 1 according to an embodiment 4 of the present invention. A difference between this embodiment 4 and the embodiment 1 is that the first inner conductor unit 12 in the embodiments is replaced with a third inner conductor unit 12b.

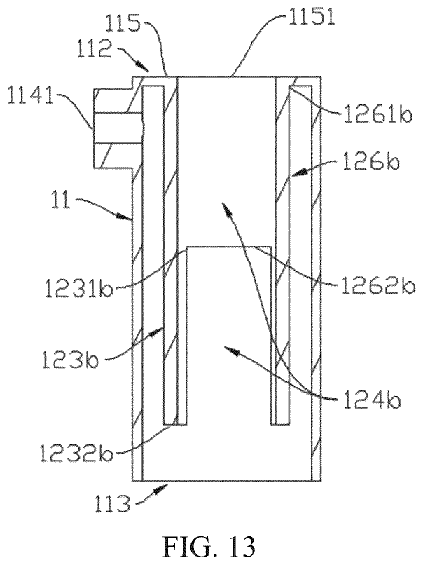

As shown in FIG. 12 and FIG. 13, the third inner conductor unit 12b is arranged in the cavity 111 of the outer conductor unit 11, and the axial height of the third inner conductor unit 12b is smaller than the axial height of the cavity 111 of the outer conductor unit 11. The top end (equivalent to the first fixed end 121) of the third inner conductor unit 12b is integrally combined on a circumference position of the first end wall 115 at the through hole 1151, and the bottom end (equivalent to the first free end 122) of the third inner conductor unit 12b extends toward the second open end 113 of the outer conductor unit 11, and is suspended in the cavity 111. The third inner conductor unit 12b may define third accommodating space 124b in the cavity 111. The third accommodating space 124b is formed to run through the third inner conductor unit 12b in the longitudinal direction, so that the aerosol generation product 2 can pass through the third accommodating space 124b when extending into the cavity 111. In addition, the inner wall surface of the third accommodating space 124b may be tightly attached to the peripheral surface of the aerosol generation product 2, to clamp and fix the aerosol generation product 2.

In this embodiment, the third inner conductor unit 12b includes the conductor portion 126b and two third extension portions 123b integrally combined on the conductor portion 126b.

The conductor portion 126b is in a tubular shape, the inner diameter of the conductor portion 126b is equal to the aperture of the through hole 1151 of the outer conductor unit 11, and the inner diameter is further equal to or slightly smaller than the diameter of the aerosol generation product 2, to clamp and fix the acrosol generation product 2. The conductor portion 126b includes the first end surface 1261b and the second end surface 1262b opposite to each other and in annular shapes and a central channel running through the first end surface 1261b and the second end surface 1262b. The first end surface 1261b is integrally integrated on the first end wall 115 of the outer conductor unit 11, and the central channel is in communication with the through hole 1151 of the outer conductor unit 11.

As shown in FIG. 12 and FIG. 13, the two third extension portions 123b are mirror-symmetric along the axis of the outer conductor unit 11, and are equally spaced away in the circumferential direction of the second end surface 1262b. The extension direction of the entire first extension portion 123 is parallel to the axial direction of the outer conductor unit 11. The third accommodating space 124b is formed between the two first extension portions 123, and is approximately a cylindrical channel.

In this embodiment, the third extension portion 123b is in a longitudinal arc structure, and may include a third fixed end 1231b (equivalent to the second fixed end 1231) and a third free end 1232b (equivalent to the second free end 1232). The third fixed end 1231b is integrally combined on the second end surface 1262b of the conductor portion 126b, and the third free end 1232b extends toward the second open end 113 of the outer conductor unit 11.

Preferably, the inner recess peripheral surface of the third extension portion 123b faces the longitudinal axis of the outer conductor unit 11, and the radian of the third extension portion 123b matches the radian of the outer peripheral surface of the aerosol generation product 2, so that when the aerosol generation product 2 extends into the third accommodating space 124b, the outer peripheral surface of the aerosol generation product 2 may be tightly attached to the inner recess peripheral surface of the third extension portion 123b.

It may be understood that, the inner peripheral wall surface of the conductor portion 126b and the inner recess peripheral surface of the third extension portion 123b together define the third accommodating space 124b. When the aerosol generation product 2 is inserted into the cavity 111, the inner peripheral wall surface of the conductor portion 126b is attached to the outer peripheral side surface of the aerosol generation product 2 in the circumferential direction. In addition, the inner recess peripheral wall surfaces of the two third extension portions 123b are respectively attached to some outer peripheral side surfaces of the aerosol generation product 2 in the axial direction, to better clamp and fix the aerosol generation product 2.

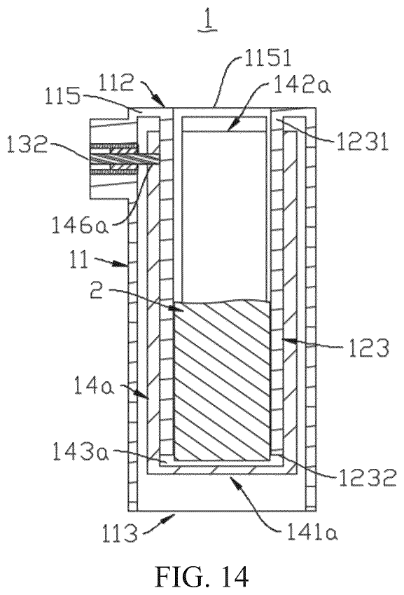

Referring to FIG. 14 together, FIG. 14 is a microwave heating assembly 1 according to an embodiment 5 of the present invention. A difference between this embodiment 5 and the embodiment 1 is that the first accommodating base 14 in the embodiment 1 is replaced with a second accommodating base 14a.

In this embodiment, the second accommodating base 14a is sleeved on the outer periphery of the first inner conductor unit 12, and may define a second accommodating cavity 143a, to completely wrap the lower structure of the aerosol generation product 2 and support the aerosol generation product 2.

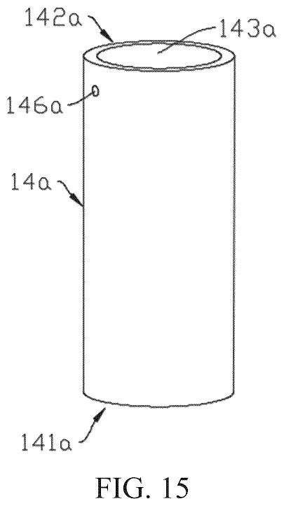

As shown in FIG. 15, the second accommodating base 14a is in a tubular shape, and may include a second closed end 141a (equivalent to the first closed end 141) and a fourth open end 142a (equivalent to the third open end 142). The second closed end 141a is located between the second free end 1232 of the first extension portion 123 and the second open end 113 of the outer conductor unit 11. The fourth open end 142a extends toward the first open end 112 of the outer conductor unit 11, and has a spacing with the first end wall 115. The inner wall surface of the second accommodating base 14a defines the second accommodating cavity 143a closed in the circumferential direction and at the bottom, and the second accommodating cavity 143a accommodates the lower structure of the aerosol generation product 2 therein.

Referring to FIG. 14, when the second accommodating base 14a is sleeved on the outer periphery the first inner conductor unit 12, some outer convex peripheral surfaces of the two first extension portions 123 and bottom surfaces of the two first extension portions 123 are respectively attached to the inner wall surface of the second accommodating base 14a. In this case, projections of the two first extension portions 123 on the first end wall 115 of the outer conductor unit 11 are located at the inner periphery of a projection of the second accommodating base 14a on the first end wall 115, and are attached to the inner periphery of the projection of the second accommodating base 14a.

In this embodiment, the peripheral wall of the second accommodating base 14a is further provided with a radial running-through perforation 146a. As shown in FIG. 14, two orifices of the perforation 146a respectively face the feeding hole 1141 of the outer conductor unit 11 and the outer convex peripheral surface of the extension portion, so that when the inner conductor 132 of the microwave feeding unit 13 extends into the cavity 111, the inner conductor 132 passes through the outer peripheral wall of the second accommodating base 14a, and then abuts against the outer convex peripheral surface of the extension portion.

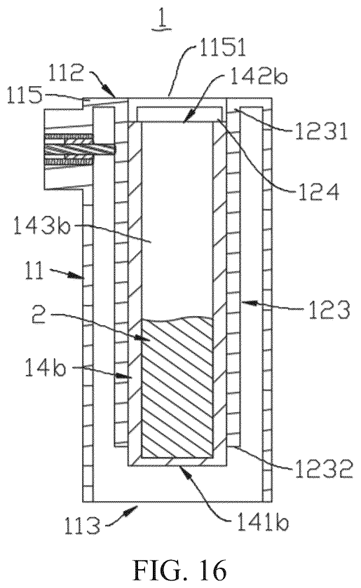

Referring to FIG. 16 together, FIG. 16 is a microwave heating assembly 1 according to an embodiment 6 of the present invention. A difference between this embodiment 6 and the embodiment 1 is that the first accommodating base 14 in the embodiment 1 is replaced with a third accommodating base 14b.

The third accommodating base 14b is embedded in the first accommodating space 124 between the two first extension portions 123, and may define a third accommodating cavity 143b, to completely wrap the lower structure of the aerosol generation product 2 and support the aerosol generation product 2.

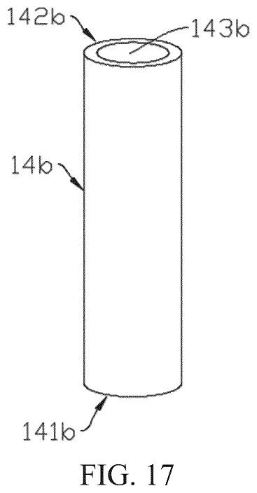

As shown in FIG. 17, the third accommodating base 14b is in a tubular shape, the inner diameter of the third accommodating base 14b is larger than the outer diameter of the aerosol generation product 2, and the outer diameter of the third accommodating base 14b is smaller than the aperture of the through hole 1151 of the outer conductor unit 11, and the third accommodating base 14b is embedded between the two first extension portions 123. The third accommodating base 14b may include a third closed end 141b (equivalent to the first closed end 141) and a fifth open end 142b (equivalent to the third open end 142). The third closed end 141b is located between the second free end 1232 of the first extension portion 123 and the second open end 113 of the outer conductor unit 11. The fifth open end 142b extends toward the first open end 112 of the outer conductor unit 11, and has a spacing with the first end wall 115. The inner wall surface of the third accommodating base 14b defines the third accommodating cavity 143b closed in the circumferential direction and at the bottom, and the third accommodating cavity 143b accommodates the lower structure of the aerosol generation product 2 therein.

In this embodiment, referring to FIG. 16, the third accommodating base 14b is fixed in the first accommodating space 124, the two first extension portions 123 are distributed on the outer periphery of the third accommodating base 14b, and the inner recess peripheral surfaces of the two first extension portions 123 are attached to the outer peripheral wall of the third accommodating base 14b. In this case, projections of the two first extension portions 123 on a plane of the first end wall 115 of the outer conductor unit 11 are located at the outer periphery of a projection of the third accommodating base 14b on the plane of the first end wall 115, and the projections of the two first extension portions 123 are attached to the projection of the third accommodating base 14b. However, the aerosol generation product 2 may be inserted into the third accommodating base 14b the third accommodating base 14b, and the outer peripheral surface of the aerosol generation product 2 is attached to the inner wall surface of the third accommodating base 14b.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, c.g., A and B, or the entire list of elements A, B and C.

What is claimed is:

1. A microwave heating assembly for an aerosol-generating device and heating an aerosol generation product, the microwave heating assembly comprising:
an outer conductor unit having a tubular shape and comprising a first open end and a second open end opposite the first open end; and
an inner conductor unit arranged in the outer conductor unit and forming an accommodating space configured to accommodate the aerosol generation product,
wherein the inner conductor unit comprises a first fixed end and a first free end,
wherein the first fixed end is combined on an end wall of the first open end,
wherein the first free end extends toward the second open end, and
wherein the accommodating space is between the first fixed end and the first free end.

2. The microwave heating assembly of claim 1, wherein the accommodating space runs through the inner conductor unit in a longitudinal direction.

3. The microwave heating assembly of claim 1, wherein the inner conductor unit comprises at least two extension portions, the at least two extension portions are distributed spaced away in the outer conductor unit along an annular path, and the accommodating space comprises a channel formed between the at least two extension portions, and
wherein each extension portion of the at least two extension portions comprises a second fixed end and a second free end, the second fixed end is integrally connected to the end wall of the first open end, and the second free end extends toward the second open end.

4. The microwave heating assembly of claim 3, wherein the at least two extension portions comprise a wall surface configured to be attached to an outer peripheral surface of the aerosol generation product.

5. The microwave heating assembly of claim 3, wherein a shape of the extension portion comprises a longitudinal arc shape, a straight strip shape, a curve shape, or a combination of at least one of the longitudinal arc shape, straight strip shape, and the curve shape.

6. The microwave heating assembly of claim 3, wherein the at least two extension portions comprise at least two pairs of extension portions having unequal lengths between pairs, and wherein the at least two pairs of extension portions are alternately and evenly distributed in the outer conductor unit in an annular shape.

7. The microwave heating assembly of claim 3, wherein the outer conductor unit comprises:
the conductor side wall comprising a tubular shape and having the first end and the second end opposite each other, the first end and the second end both comprising open structures, and the second end forming the second open end; and
the first end wall, sealed at a first end of the conductor side wall, the first end wall having an axial running-through through hole so as to form the first open end.

8. The microwave heating assembly of claim 7, wherein an aperture of the through hole is slightly larger than or equal to a diameter of the aerosol generation product.

9. The microwave heating assembly of claim 7, wherein the at least two extension portions are equally spaced away in a circumferential direction of the through hole.

10. The microwave heating assembly of claim 7, wherein the outer conductor unit comprises the longitudinal axis, and
wherein a side surface that is of the extension portion and that faces the longitudinal axis is flush with an edge of the through hole.

11. The microwave heating assembly of claim 3, wherein the inner conductor unit comprises a conductor portion,
wherein the conductor portion comprises a tubular shape, and comprises the first end surface and the second end surface opposite each other,
wherein the first end surface is integrally connected to the end wall of the first open end,
wherein second fixed ends of the at least two extension portions are respectively integrally connected to the second end surface,
wherein a central channel of the conductor portion is in communication with the first open end, and
wherein the accommodating space includes the central channel of the conductor portion.

12. The microwave heating assembly of claim 7, further comprising:
a temperature measurement assembly configured to measure a temperature, the temperature measurement assembly being embedded in one extension portion of the at least two extension portions.

13. The microwave heating assembly of claim 11, wherein the microwave heating assembly has an accommodating hole for accommodating the temperature measurement assembly, the accommodating hole being a blind hole that runs through the first end wall in a direction parallel to an axis of the outer conductor unit and extends toward the second free end of an extension portion of the at least two extension portions corresponding to a highest electric field strength.

14. The microwave heating assembly of claim 11, wherein the inner conductor unit comprises a hollowed portion arranged on the conductor portion and/or an extension portion of the at least two extension portions.

15. The microwave heating assembly of claim 14, wherein a shape of the hollowed portion comprises a round shape, a square shape, or a curved shape.

16. The microwave heating assembly of claim 3, further comprising:
an accommodating base mounted on the inner conductor unit, the accommodating base comprising a first closed end and a third open end opposite each other, the first closed end being located between the second free end and the second open end, and the third open end extending toward and being in communication with the first open end, and an accommodating cavity between the first closed end and the third open end, the accommodating cavity being configured for loading the aerosol generation product.

17. The microwave heating assembly of claim 16, wherein the accommodating base is sleeved on outer peripheries of the at least two extension portions, and
wherein side surfaces and bottom surfaces of the at least two extension portions are respectively attached to an inner wall surface of the accommodating base.

18. The microwave heating assembly of claim 16, wherein the accommodating base is arranged in the accommodating space,
wherein the at least two extension portions surround an outer periphery of the accommodating base, and
wherein side surfaces of the at least two extension portions are attached to an outer peripheral side wall of the accommodating base.

19. The microwave heating assembly of claim 16, wherein the side wall of the accommodating base is provided with at least two slots corresponding to positions of the at least two extension portions,
wherein the at least two slots respectively run through an end surface of the third open end and extend toward the first closed end, and
wherein the accommodating base is engaged with the at least two extension portions through the at least two slots and is embedded on the inner conductor unit.

20. The microwave heating assembly of claim 16, wherein the first closed end has an inner side end surface facing the first open end,
wherein the inner side end surface is configured to abut against a bottom end surface of the aerosol generation product, and
wherein an air inlet gap is formed between the bottom end surface and the inner side end surface when the bottom end surface abuts against the inner side end surface.

21. An aerosol-generating device, comprising:
a microwave generation device; and
the microwave heating assembly of claim 1,
wherein the microwave heating assembly is connected to the microwave generation device and in ohmic contact with the microwave generation device.
